(19) United States
(12) Patent Application Publication
(10) Pub. No.: US 2012/0049736 A1
(43) Pub. Date: Mar. 1, 2012

(54) LAMP UNIT AND ILLUMINATION APPARATUS

(75) Inventors: Tomoaki Shimizu, Yokosuka-Shi (JP); Takuro Hiramatsu, Yokosuka-Shi (JP); Kenji Takanashi, Yokosuka-Shi (JP); Toru Eguchi, Yokosuka-Shi (JP); Masahiko Kamata, Yokosuka-Shi (JP)

(73) Assignee: TOSHIBA LIGHTING & TECHNOLOGY CORPORATON, Yokosuka-Shi (JP)

(21) Appl. No.: 13/215,646

(22) Filed: Aug. 23, 2011

(30) Foreign Application Priority Data
Aug. 24, 2010 (JP) 2010-187412

(51) Int. Cl. H01J 7/44

(52) U.S. Cl. 315/53

(57) ABSTRACT

According to one embodiment, a light source is mounted on one side of a base body, a cap is mounted on the other side of the base body and a lighting circuit is mounted in the cap. In the cap, a circumferential portion is formed, and a projection portion being projected from the other side of the circumferential portion and having an inner space opened to the one side is formed. The lighting circuit has a substrate and a plurality of components mounted on the substrate. The components include a first component group mounted on a center portion of the substrate and having a height stored in the projection portion and a second component group mounted on a peripheral portion of the substrate and having a smaller height stored in the circumferential portion.

### INCORPORATION BY REFERENCE

The present invention claims priority under 35 U.S.C. §119 to Japanese Patent Application No. 2010-187412 filed on Aug. 24, 2010. The content of the application is incorporated herein by reference in their entirety.

### FIELD

Embodiments of the present invention relate to a lamp unit with a built-in lighting circuit, and an illumination apparatus using the lamp unit.

### BACKGROUND

A lamp unit having a GX 53 type cap is conventionally used. The lamp unit has a disk-shaped base body, a light source is arranged on one side of the base body, a cap is arranged on the other side thereof, and a lighting circuit is arranged between the base body and the cap.

In the cap, a circumferential portion is formed, a projection portion projecting from the other side of the circumferential portion and having an inner portion opened to one side is formed, and a pair of electrodes are projected from the other side of the circumferential portion.

The lighting circuit has a substrate and a plurality of components mounted on the substrate, and the substrate and the components are arranged in the projection portion.

Such a lamp unit can be thinned by arranging the entire lighting circuit including the substrate and the components in the projection portion of the cap.

However, since the size of the substrate is restricted within an inner diameter of the projection portion, the number of components capable of being mounted on the substrate is restricted. Therefore, in order to realize high-powered light output, there is a need to increase the number of components and upsize the substrate, but such a restriction in the size of the substrate is a stumbling block in the realization of high-powered light output.

When the substrate is simply upsized and arranged between the cap and the base body outside the projection portion, the lamp unit becomes thicker and thinning of the lamp unit is prevented.

It is an object of the present invention to provide a lamp unit which can realize high-powered light output while being kept thin, and an illumination apparatus using the lamp unit.

### BRIEF DESCRIPTION OF THE DRAWINGS

FIG. 1 is a cross sectional view of a lamp unit of an embodiment.

FIG. 2 is a perspective view of a cap and a lighting circuit of the lamp unit.

FIG. 3 is a perspective view of an illumination apparatus including the lamp unit.

### DETAILED DESCRIPTION

In a lamp unit of the present embodiment, a light source is mounted on one side of a base body, a cap is mounted on the other side of the base body and a lighting circuit is mounted in the cap. In the cap, a circumferential portion is formed, and a projection portion being projected from the other side of the circumferential portion and having an inner space opened to the one side is formed. The lighting circuit has a substrate which is larger than an inner diameter of the projection portion and arranged in the cap, facing one side of the circumferential portion and the projection portion, and a plurality of components mounted on the substrate having heights from the substrate. The components include a first component group mounted on a center portion of the substrate and having a height stored in the projection portion and a second component group mounted on a peripheral portion of the substrate and having a smaller height stored in the circumferential portion. According to the lamp unit, even when the substrate is upsized, the substrate can be efficiently arranged in the cap. Accordingly, the lamp unit can realize high-powered light output while being kept thin.

Next, the embodiment will be described with reference to the drawings.

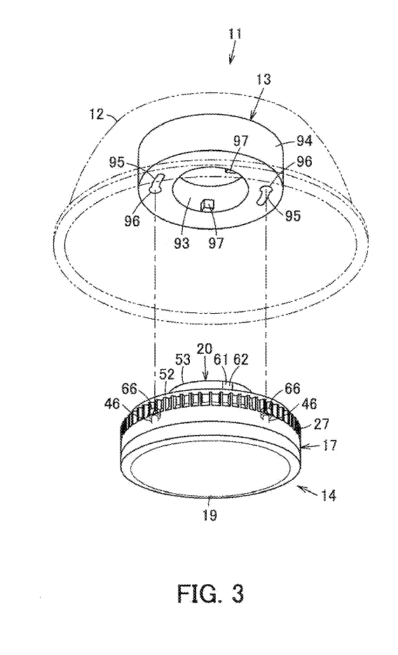

As shown in FIG. 3, an illumination apparatus 11 is, for example, a downlight, and includes an apparatus body 12, an attachment unit 13 attached to the apparatus body 12, and a flat-type lamp unit 14 detachably attached to the attachment unit 13. Moreover, hereinafter, regarding these vertical relationships, based on a state of horizontally attaching the flat-type lamp unit 14, description will be made by defining a light source side, which is one side or one end side of the lamp unit 14, as a lower side and a cap side, which is the other side or the other end side thereof, as an upper side.

The apparatus body 12 is made of, for example, metal or synthetic resin, has a reflector function with a lower face opened as a whole.

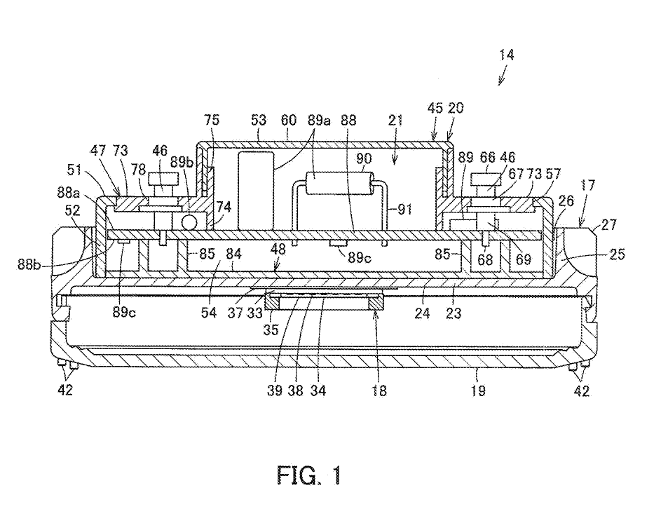

Next, as shown in FIGS. 1 to 3, the lamp unit 14 includes: a disk-shaped base body 17; a light emitting module 18 mounted on a lower face of the base body 17; a globe 19 which covers the light emitting module 18 and is attached to the lower face of the base body 17; a cap 20 mounted on an upper face of the base body 17; a lighting circuit 21 housed in the cap 20; and the like.

The base body 17 is integrally formed of, for example, metal (such as aluminum die-cast) or ceramics excellent in thermal conductivity and radiation performance. The base body 17 has a flat disk-shaped substrate mounting portion 23, a lower face of the substrate mounting portion 23 is formed into a substrate mounting face 24 on which the light emitting module 18 is thermally-conductively closely mounted, a cylindrical edge portion 25 is formed on a circumferential portion of an upper face of the substrate mounting portion 23, a circle recess-shaped cap housing portion 26 into which the cap 20 is fitted is formed inside the edge portion 25, and a plurality of heat-radiating fins 27 are formed outside the edge portion 25.

Further, the light emitting module 18 includes a substrate 33, a light emitting portion 34 formed on the center of a lower face of the substrate 33 and an insulating collar 35 which is mounted on a lower face of the substrate 33 so as to surround the light emitting portion 34. An upper face of the substrate 33 is joined to the substrate mounting face 24 of the base body 17 via an insulating sheet 37, a plurality of screws are screwed into the substrate mounting portion 23 of the base body 17 through the insulating collar 35, and thus excellent thermal conductivity is secured from the light emitting module 18 to the base body 17.

The substrate 33 is made of, for example, metal (such as aluminum die-cast) or ceramics excellent in thermal conductivity and radiation performance, and formed in the shape of a rectangular plate.

In the light emitting portion 34, for example, semiconductor light emitting elements 38 such as LED elements or EL elements are used as a light source. In the present embodiment, LED elements are used as the semiconductor light emitting elements 38 and a COB (Chip On Board) method for mounting a plurality of LED elements on the substrate 33 is adopted. That is, a plurality of LED elements are mounted on the substrate 33, and these plurality of LED elements are electrically connected in series to each other by wire bonding, and covered and sealed, as a whole, with a fluorescent matter layer 39 composed of, for example, transparent resin such as silicon resin in which fluorescent matter is mixed. For example, an LED element for emitting blue light is used as the LED element, and fluorescent matter, which is excited by a part of blue light emitted from the LED elements to emit yellow light, is mixed in the fluorescent matter layer 39. Accordingly, the light emitting portion 34 is constituted by the LED elements as the semiconductor light emitting elements 38, the fluorescent matter layer 39, etc., a surface of the fluorescent matter layer 39, which is a surface of the light emitting portion 34, serves as a light emitting face, and white illumination light is emitted from the light emitting face. In addition, the light emitting portion 34 using a method of a plurality of SMD (Surface Mount Device) packages, in which an LED element is loaded, with connection terminals may be mounted on the substrate 33.

Further, the globe 19 is made of, for example, synthetic resin or glass, has transmittance and diffuseness, is fitted to an edge portion of the base body 17 so as to cover the light emitting module 18 mounted on the substrate mounting face 24 of the base body 17 and is locked by a claw structure. A pair of display projection portions 42 for displaying electrode positions is provided on a circumferential portion of a surface of the globe 19.

Moreover, the cap 20 is a GX 53 type cap and has a cap body 45, and a pair of electrodes 46, an insulating body 47 and a cap cover 48 are attached to the cap body 45.

The cap body 45 is integrally formed made of, for example, metal such as aluminum die-cast excellent in thermal conductivity and radiation performance, and has a ring-shaped circumferential portion 51 formed at a circumferential portion of an upper face of the body, a cylindrical circumferential face portion 52 projecting downward from an edge portion of the circumferential portion 51 and a cylindrical projection portion 53 projecting upward from a central region of the circumferential portion 51. In the projection portion 53, an inner space 53a opened to the lower side is formed. The circumferential portion 51 includes the circumferential face portion 52 being projected downward from the peripheral portion. Thus, the insides of the circumferential portion 51 and the projection portion 53 of the cap body 45 are opened downward, and a lighting circuit housing portion 54 for housing the lighting circuit 21 is formed in the opening.

A plurality of bosses (not shown) are formed on an inner face of the circumferential face portion 52, a plurality of screws (not shown) are screwed to the bosses through the base body 17, respectively, and thus the base body 17 and the cap 20 are thermally conductively brought into contact with and fixed to each other. A pair of openings 57 is formed in the circumferential portion 51, the openings 57 being arranged symmetrically with respect to the center of the cap 20 at places where the pair of electrodes 46 are arranged. A top end face 60 is formed on an upper face of the projection portion 53 so as to close the projection portion 53.

A pair of key grooves 61 are formed on an outer circumferential face of the projection portion 53, the key groves 61 being arranged symmetrically with respect to the center of the cap 20 at positions deviated from the positions where the pair of electrodes 46 are arranged. Each key groove 61 has a vertical groove portion 62 formed along the vertical direction so as to communicate with the upper face of the projection portion 53 and a horizontal groove portion 63 formed on a lower portion of the projection portion 53 along a circumferential direction of the projection portion 53, and is formed substantially in an L-shape by the groove portions.

The electrode 46 is made of conductive metal, a large diameter portion 66 is formed at an upper end of the electrode 46, an attachment portion 67 to be attached to the insulating body 47 is formed at a middle portion thereof, a pin-shaped connection portion 68 to be directly connected to the lighting circuit 21 is formed at a lower end thereof, and a substrate contact portion 69 having a diameter larger than that of the connection portion 68 is formed between the attachment portion 67 and the connection portion 68.

The insulating body 47 is integrally formed of synthetic resin having insulativity, and has a pair of electrode attachment portions 73, to which the pair of electrodes 46 are attached, respectively, a substrate holding portion 74 for holding the substrate of the lighting circuit 21 and an annular insulating portion 75 arranged along an inner circumferential face of the cap 20. The pair of electrode attachment portions 73 are formed symmetrically with respect to the center of the insulating body 47, and each electrode attachment portion is fitted into each opening 57 of the cap body 45 from a lower face and attached in a state so as to be flush with an upper face of the circumferential portion 51 of the cap body 45. A hole portion 78, into which the large diameter portion 66 of the electrode 46 can be inserted and the attachment portion 67 is fitted and attached, is formed at the center of the electrode attachment portion 73. Further, the substrate holding portion 74 is annularly formed, and brought into contact with an upper face of the substrate of the lighting circuit 21 so as to control positioning of the substrate. In addition, a claw may be projected from the substrate holding portion 74 so as to hold the substrate of the lighting circuit 21.

The cap cover 48 is made of synthetic resin having insulativity and thermal insulativity and has a closing portion 84 for closing a lower face opening of the cap body 45, and pressing portions 85, which are brought into contact with a lower face of the substrate of the lighting circuit 21, is projected and formed from the closing portion 84. Further, the cap cover 48 and the substrate of the lighting circuit 21 are placed between the base body 17 and the cap 20 in fixing the base body 17 and the cap 20, each pressing portion 85 is brought into contact with the lower face of the substrate of the lighting circuit 21, and the substrate of the lighting circuit 21 is held between the substrate holding portion 74 of the insulating body 47 and the pressing portions 85.

Moreover, the lighting circuit 21 constitutes, for example, a power source circuit for outputting DC power of constant current, and includes a disk-shaped substrate 88 and a plurality of components 89 which are electronic components mounted on the substrate 88.

The substrate 88 is formed in the shape of a disk having a diameter larger than an inner diameter of the projection portion 53 of the cap 20 and smaller than an inner diameter of the circumferential face portion 52, an upper face of the substrate 88 is a mounting face 88a on which the components 89 are mounted, and a lower face thereof is a wiring pattern face 88b on which a wiring pattern is formed. Further, the substrate 88 is arranged, in the cap 20, facing the lower faces of the circumferential portion 51 and the projection portion 53 of the cap 20 at predetermined intervals, placed between the substrate holding portion 74 of the insulating body 47 and the pressing portions 85 of the cap cover 48 and held in the cap 20.

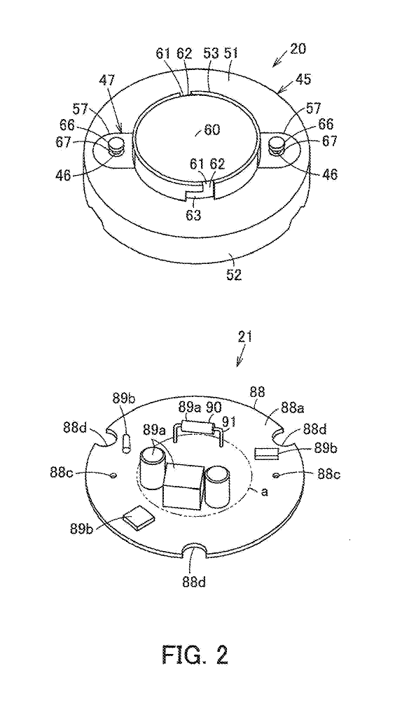

As shown in FIG. 2, the mounting face 88a of the substrate 88 is divided into a central region facing the inside of the projection portion 53 of the cap 20 and a peripheral region facing the circumferential portion 51 of the cap 20 by a virtual line a. The components 89 of the first component group 89a are mounted on the central region of the substrate 88, the first component group 89a having a height from the substrate 88 and being at least partially arranged in the projection portion 53. The components 89 of the second component group 89b are mounted on the peripheral region of the substrate 88, the second component group 89b, compared with the first component group 89a, having a smaller height from the substrate 88 and being arranged in the circumferential portion 51.

The components 89 mounted on the mounting face 88a of the substrate 88 are lead components each in which lead wires 91 project from a component body 90, and the lead wire 91 is soldered and connected to the wiring pattern on the wiring pattern face 88b through the substrate 88.

As the first component group 89a, components 89 such as an electrolytic capacitor of a rectifying and smoothing circuit for rectifying and smoothing AC voltage, an inductor of a chopper circuit for converting rectified and smoothed voltage to a predetermined voltage, a resistor used for the other circuit, etc., are included. At least a part of the component 89 arranged in the projection portion 53 includes a part of the component body 90, or the component body 90 and a part of the lead wire 91.

As the second component group 89b, components 89 such as a switching element, a capacitor, a diode, etc., of a chopper circuit are included.

The components 89, face mounting components 89c, are face-mounted on the wiring pattern face 88b of the substrate 88. As the face mounting components 89c, a chip resistor, a chip capacitor, etc., are included.

A pair of insertion holes 88c, into which the connection portions 68 of the pair of electrodes 46 are inserted, is formed in the substrate 88, the connection portion 68 of each electrode 46 is soldered to the wiring pattern on the wiring pattern face 88b inserted through the insertion hole 88c, and each electrode 46 is directly connected to the substrate 88.

Further, each electrode 46 is connected to an input terminal of an AC power source of the lighting circuit 21, and an electrical wire (not shown) connected to an output terminal of a DC power source of the lighting circuit 21 is electrically connected to the light emitting module 18 through wiring holes formed in the cap cover 48 and the base body 17.

A plurality of notch portions 88d, into which the plurality of bosses formed on the inner face of the circumferential face portion 52 of the cap 20 are fitted, are formed at an edge portion of the substrate 88.

In addition, a space between the cap 20 and the substrate 88 and components 89 of the lighting circuit 21 is filled with filling matter, for example, such as silicon resin having insulativity and thermal conductivity, so that the lighting circuit 21 is fixed to the cap 20 and heat generated from the lighting circuit 21 is efficiently thermally conducted to the cap 20.

Next, as shown in FIG. 3, the attachment unit 13 is a socket device to which the lamp unit 14 is attached for current supply and has an annular socket body 94 having an opening 93 at its center. A pair of connection holes 95, in which each electrode 46 of the lamp unit 14 are inserted and permitted to turn, is formed, symmetrically with respect to the center of the attachment unit 13, on a lower face of the socket body 94. The connection hole 95 is a long hole which is long along a circumferential direction of the socket body 94, and a expanding diameter portion 96, into which the large diameter portion 66 of the electrode 46 can be inserted, is formed at one end of the connection hole 95. A terminal (not shown), to which the electrode 46 inserted in the connection hole 95 is electrically connected, is housed in each connection hole 95.

Keys 97 are projected on an inner circumferential face of the socket body 94, the keys 97 being, so as to support the cap 20 on the socket body 94, fitted in the substantially L-shaped key grooves 61, which are formed on the outer circumferential face of the projection portion 53 of the cap 20, by turning of the electrodes 46, which are inserted in the connection holes 95, of the cap 20.

Next, operation of the illumination apparatus 11 will be described.

When the lamp unit 14 is attached to the attachment unit 13, the projection portion 53 of the cap 20 of the lamp unit 14 is inserted in the opening 93 of the attachment unit 13, a position of the lamp unit 14 in its circumferential direction is adjusted and the large diameter portion 66 of each electrode 46 is inserted in the expanding diameter portion 96 of the connection hole 95 of the attachment unit 13. Thus, the vertical groove portion 62 of each key groove 61 of the cap 20 is fitted to each key 97 of the attachment unit 13.

By turning the lamp unit 14 in an attachment direction with the lamp unit 14 pressed against the attachment unit 13, each electrode 46 of the lamp unit 14 is moved in the connection hole 95 of the attachment unit 13 and electrically connected to each terminal arranged inside the connection hole 95, each horizontal groove portion 63 of the key groove 61 of the cap 20 is fitted to the key 97 of the attachment unit 13 and the lamp unit 14 is attached to the attachment unit 13.

Moreover, power is supplied to the lighting circuit 21 from power source lines through the terminals of the attachment unit 13 and the electrodes 46 of the lamp unit 14, and thus lighting power is supplied from the lighting circuit 21 to the plurality of semiconductor light emitting elements 38 of the light emitting module 18, the plurality of the semiconductor light emitting elements 38 are lit and light is emitted from the light emitting portion 34.

Heat generated from the lit semiconductor light emitting elements 38 of the light emitting module 18 is mainly thermally conducted to the substrate 33, and thermally conducted to the base body 17 from the substrate 33, radiated into air from an outer face, which has the heat-radiating fins 27, of the base body 17, thermally conducted from the base body 17 to the cap 20, and radiated into air from the cap 20 or thermally conducted to and radiated from the attachment unit 13.

Heat generated from the components 89 of the lighting circuit 21 is mainly efficiently thermally conducted to the cap 20 via the filling matter with which the substrate 88 and the components 89 come into contact, and radiated from the cap 20 into air or thermally conducted to and radiated from the attachment unit 13.

Further, according to the lamp unit 14 of the present embodiment, since the substrate 88 is larger than the inner diameter of the projection portion 53 and arranged, in the cap 20, facing the lower faces of the circumferential portion 51 and the projection portion 53, the mounting area of the substrate 88 is increased and, even when the number of the components 89 used for the lighting circuit 21 is increased in accordance with additional higher-powered light output, these components 89 can be mounted on the substrate 88.

Since some of the components 89, the components 89 of the first component group 89a having heights stored in the projection portion 53, are mounted on a center portion of the mounting face 88a of the substrate 88, the second component group 89b having a smaller height stored in the circumferential portion 51 are mounted on a peripheral portion of the mounting face 88a of the substrate 88, the substrate 88 can be efficiently arranged in the cap 20 even when being upsized.

Moreover, the components 89 mounted on the mounting face 88a of the substrate 88 are, compared with the case of being mounted on the wiring pattern face 88b side, less influenced by heat generated from the semiconductor light emitting elements 38, and reliability of operation of the components 89 can be maintained.

Therefore, according to the lamp unit 14, high-powered light output can be realized while being kept thin.

Further, since the substrate 88 is arranged facing the circumferential portion 51 of the cap 20, the electrodes 46 provided on the circumferential portion 51 of the cap 20 can be connected to the substrate 88, wiring for connection is not required and connection work can be made easy.

Moreover, since the mounting face 88a of the substrate is arranged facing the cap 20 side including the circumferential portion 51 and the projection portion 53 and the wiring pattern face 88b is arranged away opposite from the cap 20 side, the wiring pattern face 88b is positioned away from the apparatus body 12, which is a ground portion, with the lamp unit 14 attached to the attachment unit 13. Thus, even when, on the wiring pattern face 88b, a magnetic field loop is generated by current flowing in the vicinity of the wiring pattern or noise is generated by repetition of a switching of the switching element of the chopper circuit at, for example, about 50 kHz, the level of noise leaking to the ground portion can be lowered by about −5 dB.

In addition, by using a double-face substrate, in which wiring patterns are formed on both faces of the substrate 88, as the substrate 88, the face mounting components 89c may be mounted as the second component group 89b arranged between the circumferential portion 51 and the substrate 88.

Further, the components 89 may be mounted not only on the mounting face 88a but on the wiring pattern face 88b of the substrate 88, or mounted on both faces of the mounting face 88a and the wiring pattern face 88b. In addition, the components 89 provided on the mounting face 88a of the substrate 88 are less influenced by heat generated from the semiconductor light emitting elements 38, compared with the case of being provided on the wiring pattern face 88b of the substrate 88.

Further, the light source is not limited to the semiconductor light emitting element 38, and, for example, a fluorescent lamp arranged flat along the lower face of the base body 17 may be used.

Moreover, in the above embodiment, it is allowed that the electrodes 46 of the lamp unit 14 are used for electrical connection and support of the lamp unit 14 on the attachment unit 13 and either the key groove 61 of the lamp unit 14 or the key 97 of the attachment unit 13 may not be provided. Alternatively, it is allowed that the electrodes 46 of the lamp unit 14 are used only for electrical connection and the lamp unit 14 is supported on the attachment unit 13 only by the key grooves 61 of the cap 20 and the keys 97. In this case, the large diameter portion 66 may not be provided in the electrode 46.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A lamp unit comprising:
a base body;
a light source mounted on one side of the base body;
a cap mounted on the other side of the base body, the cap including a circumferential portion and a projection portion projecting from one side of the circumferential portion and having an inner space opened to the other side of the circumferential portion; and
a lighting circuit having a substrate which is larger than an inner diameter of the projection portion and arranged in the cap facing the circumferential portion and the projection portion, and a plurality of components mounted on the substrate having heights from the substrate, wherein the components include a first component group mounted on a center portion of the substrate and having a height stored in the projection portion, and a second component group mounted on a peripheral portion of the substrate and having a smaller height stored in the circumferential portion.

2. The lamp unit according to claim 1, wherein the components are mounted at least on the side of the substrate facing the circumferential portion and the projection portion, or on both sides of the substrate.

3. The lamp unit according to claim 1, wherein the first component group includes an electrolytic capacitor and an inductor.

4. The lamp unit according to claim 1, comprising a pair of electrodes each of which having one end connected to the substrate and the other end projecting from the other side of the circumferential portion of the cap.

5. An illumination apparatus comprising:
the lamp unit according to claim 1; and
an attachment unit to which the lamp unit is attached for current supply.
